(19) United States
(12) Patent Application Publication
(10) Pub. No.: US 2009/0046393 A1
(43) Pub. Date: Feb. 19, 2009

(54) Method for reading magnetic data

(76) Inventors: Paul James Davey, Devon (GB); Desmond James Mapps, Devon (GB); Richard David Saunders, Berks (GB)

Correspondence Address: BUCHANAN, INGERSOLL & ROONEY PC, POST OFFICE BOX 1404, ALEXANDRIA, VA, 22313-1404, US

(21) Appl. No.: 11/665,655

(22) PCT Filed: Oct. 24, 2005
(86) PCT No.: PCT/GB05/04099

§ 371 Date: Dec. 13, 2007

(30) Foreign Application Priority Data
Oct. 25, 2004 (GB) 0423676.6

(51) Int. Cl. G11B 5/33

(52) U.S. Cl. 360/313; G9B/5.045

(57) ABSTRACT

A method of reading magnetic data from a magnetically-activatable sheet product carrying magnetic data. The product comprises a pair of laminated outer sheets between which is a magnetic layer comprising magnetically-activatable particles in a binder matrix. For reading the data, a thin-film magnetoresistive sensor is used in which the shape anisotropy of the sensor is enhanced in a direction transversely to the longitudinal axis of the sensor.

This invention relates to a method for reading magnetic data from laminated magnetic paper.

Sheet products capable of carrying magnetic information as well as conventional printed information are known. WO 01/92961 discloses a sheet material carrying a coating containing cavities in which electrically- and/or magnetically-activatable particles are located. WO 03/102926 describes a magnetically-activatable sheet product comprising a pair of laminated outer sheets at least one of which is provided with a pigment/binder primer coat on its inward facing surface, between which is a magnetic layer comprising magnetically-activatable particles in a binder matrix, the outer sheets having sufficient opacity to mask the appearance of the magnetic layer. WO 03/101744 describes a magnetically-activatable sheet product for use in pressure-sensitive copying paper systems.

Such products are designed for use with conventional equipment for reading and writing magnetic data. Such equipment is generally of the inductive head type. However, one disadvantage of the use of inductive head technology to read the magnetic data is that a relatively high content of magnetic material is required to be incorporated into the sheet product in order to obtain satisfactory reading of magnetic data. It would be advantageous to be able to reduce the content of magnetic material in the sheet product while retaining a satisfactory level of machine readability.

Magnetoresistive reading systems are also known, and give a higher signal strength. This would allow the use of lower contents of magnetic material in the sheet product. However, it has been found that such heads are relatively delicate and wear easily giving a relatively low life-span.

GB 2169434 describes a novel type of reading head for tape, disc and credit card applications, which comprises a thin-film magnetoresistive sensor, in which the shape anisotropy of the sensor is enhanced in a direction transversely to the longitudinal axis of the sensor.

We have now found that the use of such a sensor for reading magnetic data carried by sheet materials comprising a pair of laminated outer sheets between which is a magnetic layer comprising magnetically-activatable particles in a binder matrix, provides a number of advantages.

Accordingly the present invention provides a method of reading magnetic data from a magnetically-activatable sheet product carrying magnetic data, said product comprising a pair of laminated outer sheets between which is a magnetic layer comprising magnetically-activatable particles in a binder matrix, characterised in that there is used a thin-film magnetoresistive sensor, in which the shape anisotropy of the sensor is enhanced in a direction transversely to the longitudinal axis of the sensor.

The sensor used in the method of the present invention is of the type described in GB 2169434. Such sensors may be distinguished from conventional magnetoresistive heads by being “castellated” (or “crenellated”) in structure.

The shape anisotropy of the sensor can be increased in a direction transversely to the longitudinal axis of the sensor by selective extension of the film in a direction transversely to the longitudinal axis of the film. This can be achieved for example by forming the film with transverse fins. Such selective extension of the film in the transverse direction allows the magnetisation of the magnetic sheet to transmit its effect to the main sensing part of the film which is positioned some distance above the magnetic sheet. In other words, the fins act as a “flux guide” which is not spaced from and electrically insulated from the sensor but is an integral part of the sensor itself, leading to improved sensitivity. A further advantage of such an arrangement is that, compared with conventional magentoresistive heads, the main part of the film may be positioned relatively further away from the magnetic sheet, reducing the possibility of wear on the sensor.

If transverse fins provide the selective extension of the sensor, then they may take any one of several forms. In accordance with one embodiment of a sensor for use in the method of the invention, the ends of the fins adjacent to the magnetic sheet are widened as compared with the rest of the fin length, in order thereby to “collect” more flux. By this means the edges of the fins next to the magnetic sheet are exposed to a much greater amount of the flux available across the tracking width.

However, in a preferred embodiment of a sensor for use in the method of the invention, the fins are of a rectangular shape, the gap between each fin being small compared to the length of the edge of each fin parallel to the longitudinal axis of the sensor. Such sensors are novel, and accordingly the invention also provides a thin-film magnetoresistive sensor, which comprises a thin film on a substrate, said film being provided with a plurality of transverse fins of rectangular shape; characterized in that the distance between each fin is in the range of from 1 to 12, preferably from 1 to 4, especially from 1.5 to 2.5 microns, and the length of the edge of each fin parallel to the longitudinal axis of the sensor is in the range of from 15 to 55, preferably from 20 to 30 microns; the ratio of said length of the edge of each fin to the distance between each fin (i.e. the mark/space ratio) being at least 4:1, preferably at least 8:1. Preferably the transverse width of the sensor excluding the fins is in the range of from 15 to 55, preferably from 20 to 30, microns. Preferably the transverse width of each fin is in the range of from 15 to 55, preferably from 20 to 30, microns. Fins may be provided on only one edge of the sensor, but are preferably provided on both edges of the sensor.

An especially preferred head of this type has the distance between each fin in the range of from 1.5 to 2.5 microns and the length of the edge of each fin parallel to the longitudinal axis of the sensor in the range of from 20 to 30, microns, the ratio of said length of the edge of each fin to the distance between each fin being at least 8:1. Preferably the transverse width of the sensor excluding the fins is in the range of from 20 to 30, microns, and preferably the transverse width of each fin is in the range of from 20 to 30 microns.

It has been found that the use of rectangular fins with a relatively small gap between them provides advantages over other structures. In particular, the structure leads to good output with low noise, and also provides a resilience to damage and wear. The novel head of the invention has been found to be particularly valuable for replaying data stored on a sheet product having a relatively low content of magnetic material, for example containing a magnetic layer within the range of from 1 to 4, especially from 1.5 to 2.5, gm⁻², particularly with a spacing from 40 microns to 100 microns between the head and magnetic layer.

The present invention also provides a method of reading magnetic data from a magnetically-activatable sheet product carrying magnetic data, said product comprising a pair of laminated outer sheets between which is a magnetic layer comprising magnetically-activatable particles in a binder matrix, the method comprising the steps of:
using a thin-film magnetoresistive sensor, in which the shape anisotropy of the sensor is enhanced in a direction transversely to the longitudinal axis of the sensor, to obtain an electrical signal from the magnetic data on the sheet product,
detecting the peaks in the electrical signal obtained from the magnetic data on the sheet product,
identifying the peaks in the electrical signal obtained from the magnetic data on the sheet product as true peaks or false peaks, and
using the peaks identified as true peaks in the electrical signal obtained from the magnetic data on the sheet product to provide an output representing the magnetic data on the sheet product.

Such a method is of particular advantage in overcoming problems of weak signals and read errors when reading magnetic data from a pair of laminated outer sheets between which is a magnetic layer comprising magnetically-activatable particles in a binder matrix.

Advantageously, the method further includes the steps of:
defining windows within which peaks cannot lie if they are valid representations of the magnetic data stored on the sheet product, and
identifying true peaks and false peaks according to where the peaks occur in relation to the windows.

The windows provide a simple way of distinguishing the true peaks from the false peaks.

Preferably, peaks are detected in the electrical signal obtained from the magnetic data on the sheet product by determining the slope of the electrical signal at a multiplicity of points.

Changes in the slope of the electrical signal are simple to determine and are able to identify the location of the peaks.

Advantageously, the slope of the electrical signal obtained from the magnetic data on the sheet product is determined by repeatedly sampling the electrical signal and subtracting the value of a current sample from the value of the preceding sample.

This is a particularly simple way of determining peaks in the signal.

Preferably, a change in the sign of the result of subtracting the value of a current sample from the value of the preceding sample is used to indicate the presence of a peak.

A change in sign of the slope is simple to identify and directly indicative of the presence of a peak.

Advantageously, each window corresponds to a predetermined number of sampling periods.

This provides a particularly simple way of defining the windows. The predetermined number of sampling periods may be fixed or adjustable so as to adapt the size of the windows.

Advantageously, the method further includes the step of beginning a new window on the detection of each true peak.

This makes the identification of false peaks very simple. Preferably, the electrical signal obtained from the magnetic data on the sheet product is processed digitally.

Digital processing can be carried out both cheaply and accurately with relatively little expenditure.

Preferably, the step of using a thin-film magnetoresistive sensor, in which the shape anisotropy of the sensor is enhanced in a direction transversely to the longitudinal axis of the sensor, to obtain an electrical signal from the magnetic data on the sheet product comprises using the sensor to read data recorded using a self-clocking digital code on the sheet product.

The use of a self-clocking code is advantageous as regards both simplicity and accuracy of reading.

Preferably, the method comprises the step of using the sensor to read data recorded using Manchester code.

The use of Manchester code is particularly advantageous in the context of the invention as regards simplicity and accuracy.

Advantageously, each window is smaller than the minimum spacing between true peaks expected from the coding format of the magnetic data but larger than the spacing between a true peak and a false peak.

This enables the window to be defined, for example, as being smaller than the expected number of samples between true peaks, but larger than the expected number of samples between false peaks.

Preferably, the method further includes the step of amplifying the electrical signal obtained from the magnetic data on the sheet product using amplifying means and adjusting the gain of the amplifying means to increase the gain if the electrical signal obtained from the magnetic data on the sheet product is too small and to decrease the gain if the electrical signal obtained from the magnetic data on the sheet product is too large for the amplifying means.

By this means, inaccuracies resulting from distortion in the amplifying means can be avoided.

A number of embodiments of magnetoresistive sensors for use in the method of the invention will be described with reference to the accompanying drawings, in which:

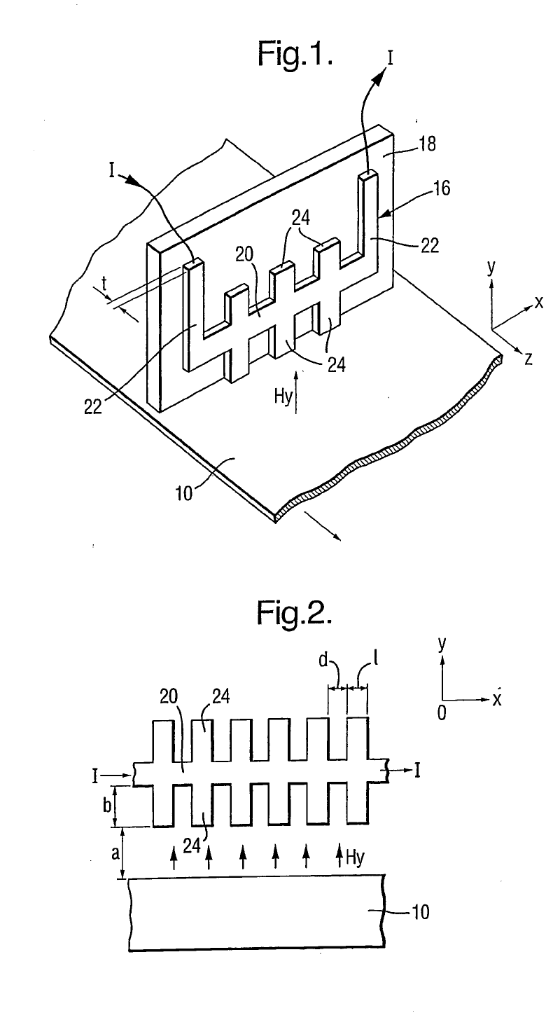

FIG. 1 shows a first embodiment of thin film magnetoresistive sensor for use in the method of the invention;

FIG. 2 shows a modification of the arrangement of FIG. 1, where the film is spaced from the surface of the magnetic sheet product;

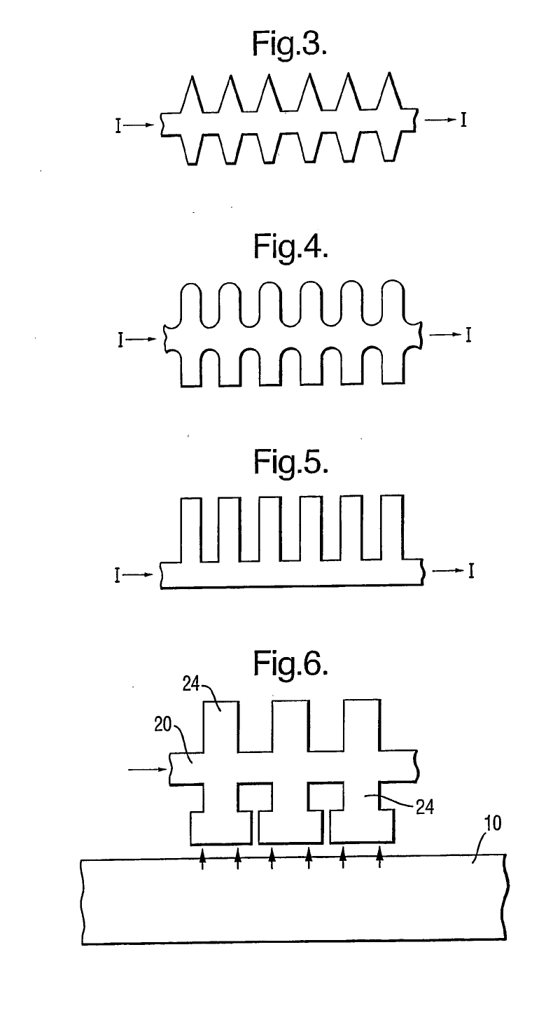

FIGS. 3 to 5 show three alternative configurations of film with different shapes of transverse fin;

FIG. 6 shows a further embodiment of a sensor having a modified fin configuration;

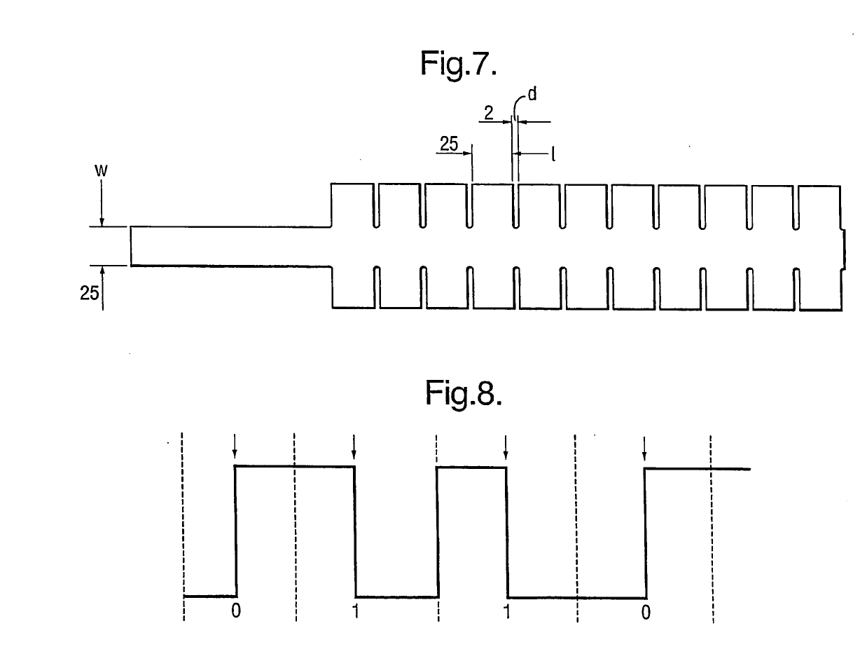

FIG. 7 shows an end portion of a preferred embodiment of a sensor;

FIG. 8 shows an example of a data signal encoded using Manchester encoding;

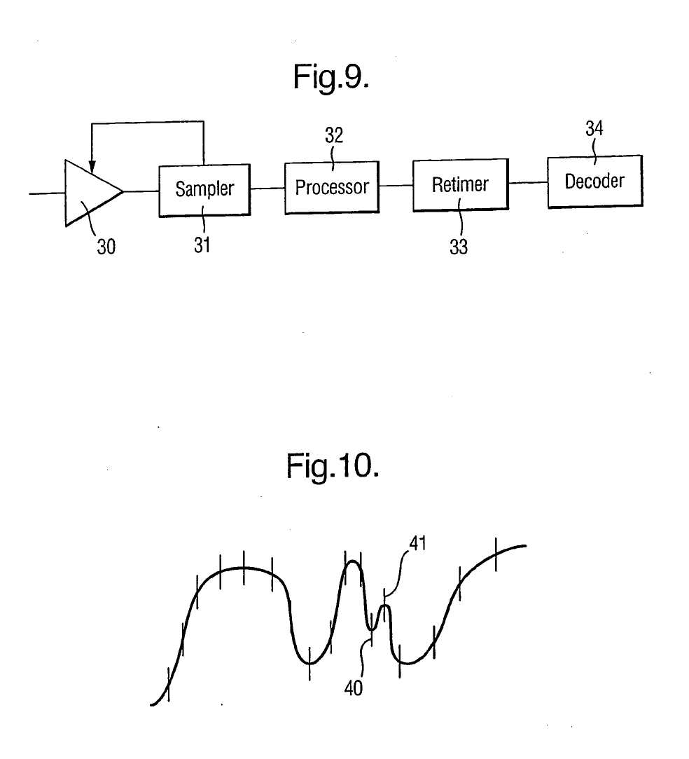

FIG. 9 shows a block diagram of a system to process and decode a signal;

FIG. 10 shows an example of a signal received when reading the data shown in FIG. 8;

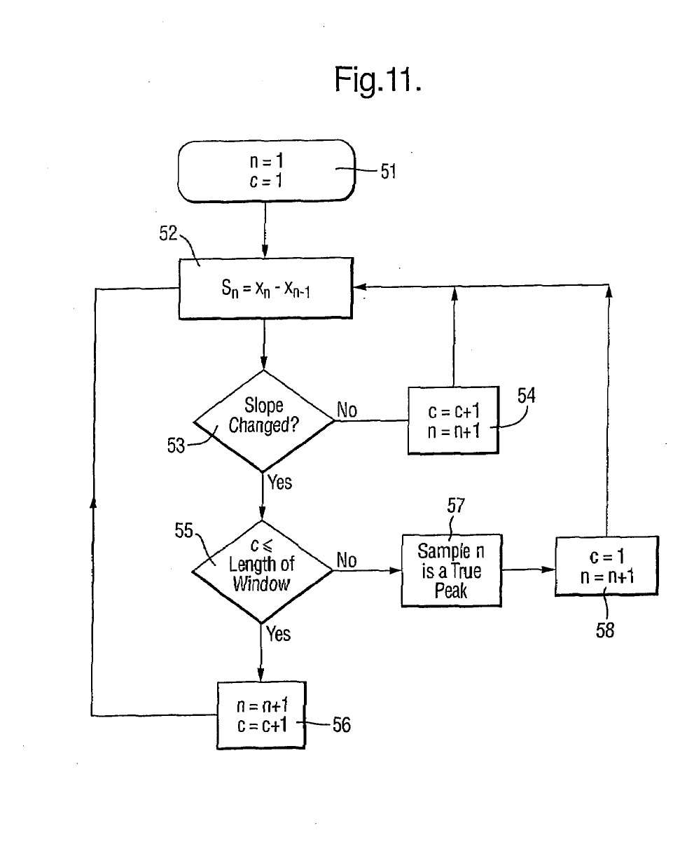

FIG. 11 shows a flow chart of a basic peak detection algorithm;

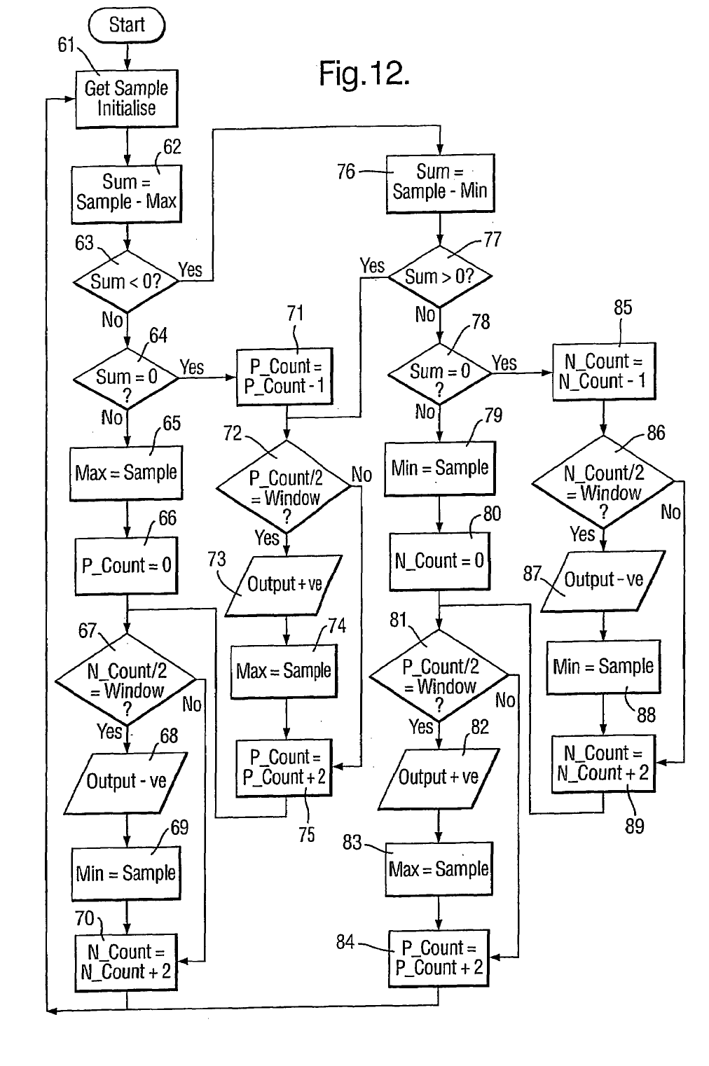

FIG. 12 shows a flow chart of a process for converting a noisy input signal, received from an MR head, into a binary output;

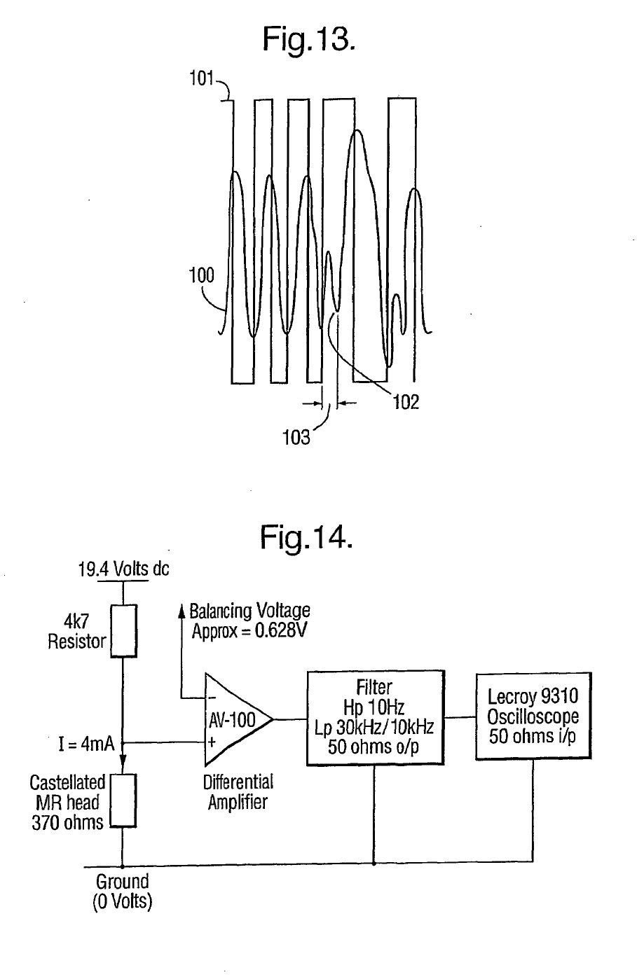

FIG. 13 shows an example of an input signal to the process of FIG. 12 and the output signal of that process;

FIG. 14 shows the experimental arrangement used in Example 1 hereinafter;

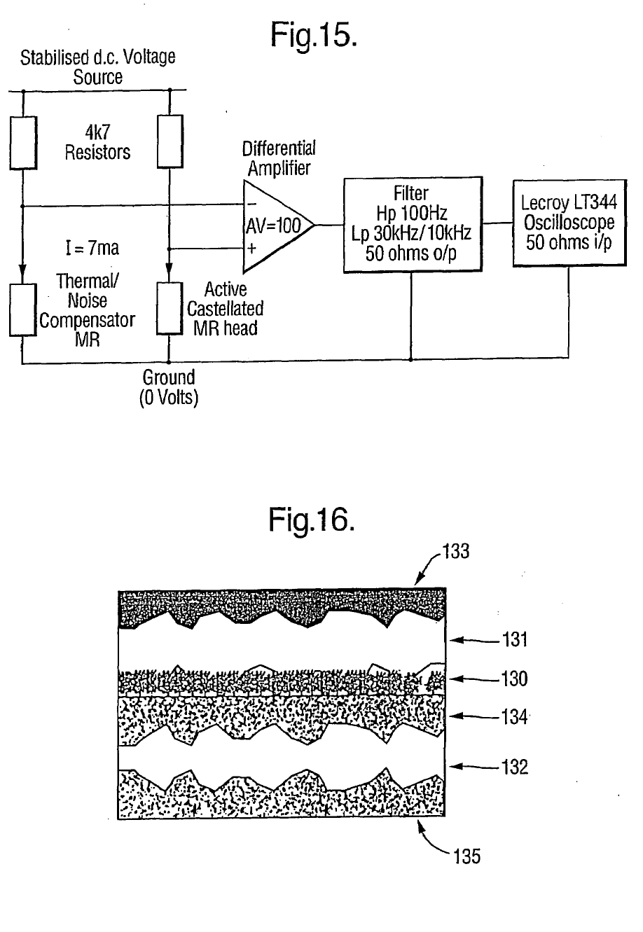

FIG. 15 shows the experimental arrangement used in Example 2 hereinafter; and

FIG. 16 shows one possible construction for a magnetic sheet product for use in the invention.

Referring now to FIG. 1, this shows a portion of a magnetic sheet product 10 carrying magnetic data, said product comprising a pair of laminated outer sheets between which is a magnetic layer comprising magnetically-activatable particles in a binder matrix magnetic sheet, which is movable in the direction shown by the arrow beneath a thin-film magnetoresistive sensor. The thin film, indicated generally at 16, is mounted on a substrate 18. The thickness t of the film 16 is exaggerated in the drawing for the sake of greater clarity. The film 16 comprises a main stripe 20 with leadouts 22 at each end. A sensing current i is supplied to one readout 22 and is taken from the other leadout 22 to associated electrical or electronic circuitry (not shown). As shown in FIG. 1, the main stripe 20 which extends across sheet 10 at right-angles to the direction of movement is provided on each side with transverse fins 24. In this particular embodiment the fins 24 are shown as being generally rectangular in shape and of equal size on each side of the main stripe 20. Although the bottom edges of the downwardly extending fins 24 may be either in contact with or slightly spaced from the surface of the magnetic sheet 10, the main stripe 20 of the film is spaced away from the surface of the magnetic sheet 10. The provision of the transverse fins 24 increases the shape anisotropy of the film in the transverse direction y. The film 16 can be produced by appropriate photolithography techniques for example. With this finned structure the field Hy from the sheet 10 will then more readily rotate the film magnetisation.

As is shown in FIG. 2, the ends of the fins 24 do not necessarily have to be in contact with the magnetic sheet 10 for the sensor to be effective. In FIG. 2 the ends of the lower fins 24 are shown spaced from the surface of the magnetic sheet 10 by a distance a. In one practical embodiment of thin-film sensor with a film configuration of the general type shown in FIG. 2, the film has 96 double fins equispaced along the main stripe 20. Each fin 20 has a length l along the x-axis of 10 μm, and the spacing d between adjacent fins along the x-axis is also 10 μm, i.e. a mark/space ratio of 1:1. The width b of each fin 24 along the y-axis is 20 μm. It is emphasised however that these values are given by way of example only. In particular, the width b could in practice be substantially more than 20 μm. In a digital device where a signal is required from two magnetic stages, these can be with the magnetisation along the x-axis as shown in FIG. 2 and along the y-axis as shown in FIG. 2. The binary-coded magnetisation transitions on the magnetic sheet then tend to switch the sensor magnetisation between the two states, and this provides an output signal by means of a change in the current i through the sensor, or in the voltage across the sensor.

FIGS. 3 to 5 show three alternative fin configurations which differ from the rectangular shape shown in FIGS. 1 and 2. FIG. 3 shows fins with a generally triangular configuration, although with the lower fins truncated at their apices. FIG. 4 shows fins of generally oval or elliptical configuration, and again with the lower fins presenting flat surfaces towards the storage medium. FIG. 5 shows a single-sided finned structure where the film presents a continuous straight edge to the storage medium but has transverse fins along the upper edge of the main stripe. Other configurations of fin structure can also be used.

FIG. 6 shows a further modified fin configuration. In FIG. 6 a magnetic sheet 10 is movable as shown. The main stripe 20 which extends across the track at right-angles to the direction of sheet movement is provided on each side with transverse fins 24. The upper fins 24 are rectangular, and may be longer than shown in the drawing. This embodiment is concerned with the lower fins which extend from the main stripe 20 towards the sheet 10. The end portion of each lower fin 24 adjacent to the sheet is widened so that each of these lower fins has an inverted T-shape configuration. Although as shown in FIG. 6, the height of the broadened fin portion is substantially equal to the height of the narrower fin portion which connects that broadened portion to the main stripe 20, the length of the narrower fin portion can be increased in proportion to the length of the broadened portion.

FIG. 7 shows an especially preferred fin configuration. In the sensor of FIG. 7, two rows of fins are present, each fin being rectangular. In contrast, however, to the head of FIG. 2, in which the length l of each fin is equal to the distance d between each fin, each distance being 10μ, in the head of FIG. 7 the distance d between each fin is small: in the particular head of FIG. 7, the distance d between fins is 2μ; the length l of each fin is 25μ; the transverse width of the strip w is 25μ; and the width of each fin is 25μ.

According to an example of the current invention, data is encoded onto a sheet of the paper described below, using a defined coding system which in the current example is a Manchester code. The Manchester code is advantageous as it is a self-clocking code, which removes the need for an external clock source in order to decode the data.

In a Manchester code binary data bits are represented by transitions in the signal, rather than by absolute values of that signal. The use of transitions to represent the data ensures there is a transition in every bit period (in contrast to a code which uses the absolute level of the data to indicate a value, where transitions only occur when the data changes).

FIG. 8 shows an example of a data signal encoded utilising Manchester encoding. Bit periods are indicated by the vertical dashed lines, with the solid line indicating the signal. In this example a ‘0’ is indicated by a low-to-high transition at the centre of a bit period and a ‘1’ is indicated by a high-to-low transition at the centre of a bit period, as shown by arrows in FIG. 8. As can be seen in FIG. 8 there is always a transition in the centre of each bit period and there may be a transition at the end or beginning of each bit period.

Another feature of Manchester encoding is that the period between transitions can only be either half a bit period, or a full bit period.

An example of processing and decoding a signal received from a read head, as described above, will now be given. FIG. 9 shows a block diagram of a system to process and decode the data.

The signal is first amplified by a suitable amplifier 30 so that it is approximately equal to the full-scale of the sampler 31. In order to adjust for variation in the peak magnitude of the signal, the gain of the amplifier is controlled by the sampler. By monitoring the magnitude of the input signal the sampler increases the gain if that input is too small, and decreases the gain if that input is too large.

The signal is then sampled by the sampler 31 so that digital processing by a processor 32 can be utilised to process the data. The output of the processor is passed to a retiming device 33 and then on to a decoder 34.

A fixed sampling rate is utilised by the sampler so that the location of features, such as peaks and transitions, within the signal can be determined from the number of samples between such features.

Due to imperfect reading of the signal and noise in the reading system, the signal will not be a perfect representation of the encoded data. FIG. 10 shows an example of a signal received when reading the data shown in FIG. 8. The vertical dash marks indicate the position of samples.

Data is encoded by transitions in the signal, and therefore in order to decode the data the location of transitions must be detected. A way of detecting transitions in a signal is to compare the signal with a threshold, and each time the signal crosses that threshold a transition has occurred. That method is not efficient, however, if the amplitude and offset of the signal is variable, as is the case with a signal read by an MR head, since the level of the threshold would have to be moved in response to changes in the signal. In order to identify transitions in the signal the fact that each transition corresponds to a peak in the signal is utilised. By identifying peaks, which are easier to identify in a signal with variable amplitude and offset, the location of transitions can be determined and consequently the data can be decoded.

Noise is present on the received signal and affects, on a random basis, the magnitude of samples. A particular problem is that it can lead to the detection of false peaks in the signal.

In FIG. 10 there is a pair of false peaks at 40 and 41, present due to noise affecting the value of sample 41. If these peaks were identified as true peaks and used in the decoding of the data the decoding would be incorrect.

The possible positions of transitions (and hence peaks) are defined by the code utilised. Should a peak occur close to another peak before a peak is permitted by the code then that peak can be identified as being false. A window located after each peak is used to identify such false peaks. The window is defined as being smaller than the number of samples between correct peaks, but larger than the expected number of samples between false peaks. If a peak occurs within the window following another peak it is ignored as being false and not identified as a peak to be used as the basis of decoding the data.

The length of the window used to identify false peaks can be a fixed value, or can be altered on a dynamic basis depending on parameters such as the error rate of the decoded data. The error rate can be calculated by the decoder and fed back to the processor.

FIG. 11 shows a flow chart of a basic peak detection algorithm. The following variables are used through the algorithm:—
n—counter to indicate sample number being processed
xₙ—sample value
c—counter to indicate number of samples since last peak
Sₙ—slope between sample n and sample (n−1)

At step 51, n and c are reset to ‘1’ to initiate the algorithm. At step 52, the slope between the nth sample and the (n−1)th sample, is calculated by subtracting the value of the (n−1)th sample from the nth sample. This value is stored in Sₙ. At step 53, a decision is taken according to a comparison of the sign of the current slope to the sign of the previous slope (when the algorithm is first started an assumption must be made about the starting slope previous to the first sample, for example that it was flat). If the signs of the slopes are the same then there has been no peak between this pair of samples and the previous pair of samples. In that case the values of n and c are incremented at step 54 and the algorithm returns to step 52. If the signs of the slopes are different (or if the current slope is zero indicating the signal is constant), then a peak has been detected. At step 55, the value of c is then compared to the pre-defined length of the window. If c≦the length of the window then the peak detected is a false peak. In that case at step 56, c and n are incremented and the algorithm returns to step 52. On the other hand, if c is greater than the length of the window in step 55 then the peak is a true peak and the algorithm moves to step 57. At step 57, the nth is recorded as being a peak and in step 58, c is reset to ‘1’ and n is incremented. The process then returns to step 52.

In this manner the algorithm steps through the samples and records the locations of all true peaks within the samples. This information is then utilised by the retimer 33 to locate the transitions in the data, which indicate the data content.

A more detailed flow chart showing an example of a process for converting a noisy input signal, received from an MR head, into a binary, digital output, suitable for further processing and decoding, is shown in FIG. 12. That process will now be described with reference to that Figure.

The following variables are utilised in the algorithm:—
Sample—magnitude of the current sample
Max—Maximum sample magnitude since the last peak
Min—Minimum sample magnitude since the last peak
Sum—Temporary store
P_Count—Count since last positive peak
N_Count—Count since last negative peak
Window—Defined as a number of samples during which peaks are ignored
Output—Binary value, indicating the level of the input signal

At step 61, all variables are initialised at zero, and the first sample is read into the algorithm. At step 62 the currently stored Max value is subtracted from the current sample and the result placed into Sum. At step 63, the value of Sum is tested—if the value is less than zero the signal has a downwards slope at that point, if the value is greater than zero the signal has an upwards slope at that point. The algorithm then branches accordingly.

Assuming Sum is not less than zero the algorithm moves to step 64, where Sum is compared to zero. If Sum is zero the signal is level.

Assuming Sum is greater than zero the algorithm moves to step 65 where the current sample is stored in Max (the curve is sloping upwards and therefore the current sample is a new maximum value). At step 66, the value of P_Count (a count since the last positive peak) is reset to zero.

At step 67, the current value of N_Count is compared to the value of window (which indicates the minimum allowable distance between peaks). N_Count is divided by two due to processing restrictions in the handling of N_Count. If the value of N_Count is not equal to Window then the current sample cannot be a peak.

Assuming that N_Count/2 is less than Window the algorithm moves to step 70 where N_Count is increased by 2. The algorithm then returns to step 61 to process the next sample.

If at step 67 the value of N_Count is equal to Window, the algorithm moves to step 68, in which an output of the processor is set to a negative value since a real peak has been identified (indicated in note form in step 67 as ‘Output −ve’). As discussed above peaks indicate transitions in the data and so each time a true peak is detected the output is changed to indicate a transition. At step 69 the current sample is transferred to the variable Min, and the algorithm then returns to step 70.

Steps 76 to 84 are followed if the algorithm identifies a signal with a downwards slope at step 63. Steps 76 to 84 work in the same way as steps 62 to 70 described above, but look for a negative peak, and therefore the variables Min and P_Count are used in place of Max and N_Count.

Steps 71 to 75 are used to identify the location of a peak when the signal is level (for example if the input to the sampler has too high a peak value and is ‘clipped’ by the sampler). Operation is the same as described for steps 67 to 70, except that due to the combination of steps 71 and 75 the counter is only increased by 1 per sample in order to identify the centre of the peak. Steps 85 to 89 operate in the same way as steps 71 to 75.

FIG. 13 shows a typical input signal 100 and an associated output signal 101 generated by the algorithm described above. As can be seen the output signal has a transition located at each peak, except where a peak occurs too soon after a previous peak. Peak 102 falls within the window 103 located after the previous peak and is therefore identified as a false peak.

The output of the above algorithm is a binary waveform containing transitions at each true peak location.

Although peaks occurring too close to a previous peak are removed by the above algorithm, it is still possible that the exact locations of the peaks (and hence transitions) have not been determined.

Shifting of peaks in the signal, compared to their true location, occurs due to degradation of the signal as it passes through the read head, amplifier and sampling apparatus. Such shifting is known as Inter-Symbol Interference (ISI). By correcting the location of peaks, the quality of the signal, and hence the accuracy of the decoded data, can be improved. After passing through the sampler 31 and processor 32 the binary signal from the processor 32 is passed to a re-timing device 33 which monitors and adjusts the locations of the transitions.

In a Manchester code the period between transitions is, as stated above, always either a whole period or half of a period, and hence the ratio of one period between transitions and the subsequent period between transitions will always be 2:1, 1:1 or 1:2. The ratio between two adjacent periods between transitions is determined and compared to the possible ratios. If the result is close, but not exactly equal, to a possible ratio then the last transition is marked as being incorrectly located. For example, if the ratio was 1.1:1, it is likely that the final transition has been recorded as being too late and that the ratio should be 1:!. This fact is recorded such that the transition can be adjusted when decoding the data.

In an alternative processing apparatus the positions of the transitions are altered immediately, as they are detected, as opposed to being marked. Furthermore the comparison can be made over a number of transitions such that the position of a transition is adjusted based on a number of previous periods between transitions, as opposed to only the previous one, as described above.

Once the signal has been retimed it is passed to a decoder 34 which extracts the data from the signal.

The sheet product used in the method of the invention may be formed as described in WO 03/102926. For example, the magnetic layer may be formed by a coating on the inwardly facing surface of one or both of the outer sheets, or it may be formulated as a laminating adhesive which is applied as or just before the two outer sheets are brought together in a laminating press or similar equipment.

The magnetic layer can be formulated from magnetically-activatable materials, for example chromium dioxide, iron oxide, polycrystalline nickel-cobalt alloys, cobalt-chromium or cobalt-samarium alloys, or barium-ferrite. The binder used can be selected from, for example, a polyvinyl alcohol, a latex, a starch or a proteinaceous binder such as a soy protein derivative. It is preferably a styrene-butadiene or acrylic or other latex. The coatweight applied may be varied in accordance with the level of magnetic signal required. The magnetic layer can if desired contain an extender such as calcium carbonate, which not only offers cost reduction but also helps to reduce the darkness of the magnetic layer.

A laminating binder or adhesive is normally used to secure the sheets together, sandwiching the magnetic layer, to form the laminate. Such a binder may be, for example, a polyvinyl alcohol, a latex, a starch or a proteinaceous binder such as a soy protein derivative.

In a preferred embodiment, one or both outer sheets in such a product carry a pigment/binder primer coat on its inward facing surface. This primer coat is typically formulated from conventional coating pigments as used in the paper industry, for example calcium carbonate (particularly precipitated calcium carbonate), kaolin or other clays (particularly calcined clays) and/or, where high opacity is required and justifies the extra cost, titanium dioxide. The binder used can be conventional, for example a latex (particularly a styrene-butadiene or acrylic latex), a starch or starch derivative, a polyvinyl alcohol and/or a soy protein derivative or other proteinaceous material. The primer coatweight is typically in the range of about 5 to 15 g m⁻², but this can vary in accordance with the masking effect desired and the weight of the outer sheets used (heavier base papers normally require lower primer coatweights). Where the product contains only one outer sheet bearing an inward-facing primer coat, magnetic data is preferably written to and read from the side of the product carrying the primer coating.

Preferably the sheet product used in the method according to the invention is constructed using outer sheets which are sufficiently opaque such that, in the finished product, the appearance of the magnetic layer is masked. The outer sheets are preferably made of paper, although plastic sheet materials which simulate the properties of paper (so-called “synthetic paper”) can alternatively be used. The material used for the outer sheets are preferably such as to provide a satisfactory masking effect and desirability and also a good final product appearance. The outer sheets will be of a base paper such that when laminated, the final product will not be excessively thick or heavy. In general, an outer sheet will be regarded as having sufficient coverage/opacity to mask the appearance of the magnetic layer if the whiteness of the resulting product, measured on an Elrepho 3000 instrument with the use of UV light enhancement, is within 5 points of the original base sheet on the L scale. Preferably the whiteness approaches that of the original base sheet used to produce the product.

The sheet product used in the process of the present invention may also contain one or more additional layers, depending upon the intended use of the product. It may for example contain one or two additional coating layers to produce a sheet for a pressure-sensitive copying system. For example, the sheet may comprise a CF layer, a CB layer or an autogenous layer via a single coating. A CFB sheet could comprise CB and CF coating layers applied to opposite sides of the sheet. Thus, a sheet product for use in the method of the invention may comprise a pair of laminated outer sheets between which is a magnetic layer comprising magnetically-activatable particles in a binder matrix; at least one of the outer sheets being provided on its outward facing surface with a coating which comprises either microcapsules containing a solution of at least one chromogenic material, or dispersed droplets containing at least one chromogenic material in a pressure-rupturable matrix, or a colour developer composition, or both microcapsules containing at least one chromogenic material and also a colour developer. Such sheets are described in WO 03/101744.

Alternatively, a sheet product for use in the method of the invention may comprise a thermal coating or a layer of thermal ink, to produce a product which is capable of recording visible information applied by a thermal printer, as well as magnetic data. Preferably such a product comprises (i) a pair of laminated outer sheets between which is a magnetic layer comprising magnetically-activatable particles in a binder matrix; (ii) at least one layer applied to the outward facing surface of one of the outer sheets, said layer comprising a pigment and a binder; and (iii) a thermal coating or a thermal ink applied to said layer (ii). The pigment in layer (ii) of the product of the invention may for example be a pigment in solid porous particulate form. The pigment preferably comprises kaolin or another clay, particularly calcined clay, calcium carbonate (particularly in precipitated form, which is porous and of high absorptivity), silica, and/or titanium dioxide. Alternatively or in addition, the coating may comprise a plastic pigment in the form of hollow spheres. The binder used in layer (ii) can be conventional, for example a latex (particularly a styrene-butadiene or acrylic latex), a starch or starch derivative, a polyvinyl alcohol and/or a soy protein derivative or other proteinaceous material. The thermal coating or thermal ink of layer (iii) comprises a colour developer, a colour former and a sensitizer.

FIG. 16 shows one possible sheet product for use in the present invention. A magnetic layer 130 comprising magnetically-activatable particles in a binder matrix is laminated together with two sheets of paper 131 and 132. The sheet 131 optionally carries an outer layer 133 which may, for example, be a CF or a CB or a thermal layer. The sheet 131 optionally carries an inner pigment binder layer 134, and also an outer top-coating layer 135, for example a gloss coating.

In general, when using a conventional inductive magnetic reading system to read magnetic data on a sheet product comprising a pair of laminated outer sheets between which is a magnetic layer comprising magnetically-activatable particles in a binder matrix, around 8 to 10 gm⁻² of magnetic pigment is required if each outer paper sheet has a thickness of around 60 μm, in order to give a satisfactory magnetic signal for conventional inductive magnetic reading systems. In addition, use of thicker outer paper sheets is undesirable as the strength of the signal diminishes rapidly with distance of the inductive head from the magnetic layer. Use of the method of the present invention permits the use of a layer of magnetic pigment of from 1 to 7 gm⁻², for example from 1 to 4.5 gm⁻², and in some cases as little as 1 to 2 gm⁻², and also permits the use of a bigger spacing between the layer of pigment and the reading head, thus allowing the use of a thicker outer sheet if desired.

Use of the present invention also permits the use of a low coercivity magnetic pigment. Preferably the magnetically-activatable material has a low coercivity, i.e. less than 1000 oersteds, preferably less than 500 oersteds. The use of high coercivity materials leads to a material which is difficult to demagnetise and hence is tolerant of stray magnetic fields in the environment. Such materials are, however, expensive, and also suffer from the technical disadvantage that they require the use of high magnetic fields to write magnetic information. Unlike known systems, the use of the present system is tolerant of stray magnetic fields, which enables the use of low coercivity materials.

The following Examples illustrate the invention.

### EXAMPLE 1

Several samples of a sheet product comprising a pair of laminated outer sheets between which is a magnetic layer comprising magnetically-activatable particles in a binder matrix, were manufactured using the general method described in WO 03/102926. The two sheets used were as follows—

Sheet 1—60 μm thick base with pre-coat (pre-coat formulation was 5-10 gm⁻² calcium carbonate and latex)
Sheet 2—80 gm⁻² Carbonless CF

These sheets were laminated on a laminator via an aqueous glue roll application system using a 1:1 (dry) mixture of magnetic pigment ink (DWFPN022 from Pyral) and a styrene-butadiene latex laminating glue to give a range of different dry magnetic pigment coatweights between about 3 and 14 gm⁻².

A data track was written onto each of these samples using a Tally Genicom T5200 ticket printer modified to write at 75 bpi. These samples were then checked for magnetic data readability on the same T5200 ticket printer (which contains inductive heads). A 2 mm wide castellated magnetoresistive head (MR head) profiled to approximately 100 μm from the reading surface was then used to replay the data signal written on the different magnetic papers. A high pass filter of 10 Hz was used to remove thermal effects on the MR head. A low pass filter was also used to reduce high frequency noise. A diagram for the experimental set up is shown in FIG. 14.

The results were as follows.

| Magnetic pigment dry | T5200 readable | MR output (mV |
|---|---|---|
| coatweight (gm⁻²) | (comparison) | peak to peak) |
| 14.0 | Yes | 603 |
| 5.4 | Occasional | 254 |
| 2.8 | No | 164 |

It can be seen that using a conventional inductive reading head, a relatively high coatweight of magnetic pigment was required. In contrast, using the MR head, satisfactory reading was obtained right down to below 3 gm⁻², a peak to peak output of 164 mV being fully readable.

### EXAMPLE 2

The experimental set-up used in this Example is shown in FIG. 15; the set-up is similar to that of Example 1 save that an additional MR head identical to the active reading MR head was introduced to provide noise/thermal compensation, i.e. to cancel out common mode electronic and magnetic noise. This compensation head was placed some distance behind the active MR head and at right angles to it.

Two different data code tracks were written using a Tally inductive replay head, onto a laminate sheet similar to that of Example 1, prepared using Sheet 1 and having a dry magnetic pigment coatweight of 2 gm⁻². Three separate castellated heads were used to read the data tracks: (i) the head shown in FIG. 7 in which the distance between each fin is 2μ, the length of the edge of each fin parallel to the longitudinal axis of the sensor is 25μ, the transverse width of the sensor excluding the fins is 25μ, and the transverse width of each fin is 25μ; (ii) a similar head in which the distance between each fin is 10μ, the length of the edge of each fin parallel to the longitudinal axis of the sensor is 50μ, the transverse width of the sensor excluding the fins is 50μ, and the transverse width of each fin is 50μ; and (iii) a similar head in which the distance between each fin is 2μ, the length of the edge of each fin parallel to the longitudinal axis of the sensor is 25μ, the transverse width of the sensor excluding the fins is 50μ, and the transverse width of each fin is 25μ.

In each case, the signal output from the read head was processed according to the algorithm described above with reference to FIG. 12.

The results obtained showed excellent readability, and also excellent reproducibility when using the same MR head and paper sample. Head (i) proved particularly favourable.

1. A method of reading magnetic data from a magnetically-activatable sheet product carrying magnetic data, said product comprising a pair of laminated outer sheets between which is a magnetic layer comprising magnetically-activatable particles in a binder matrix, wherein there is used a thin-film magnetoresistive sensor, in which the shape anisotropy of the sensor is enhanced in a direction transversely to the longitudinal axis of the sensor.

2. A method as claimed in claim 1, in which the sensor comprises a thin film on a substrate, and said film is provided with transverse fins.

3. A method as claimed in claim 2, in which the ends of the fins adjacent to the sheet product are widened as compared with the rest of the fin length.

4. A method as claimed in claim 2, in which the distance between each fin is in the range of from 1 to 12 microns, and the length of the edge of each fin parallel to the longitudinal axis of the sensor is in the range of from 15 to 55 microns; the ratio of said length of the edge of each fin to the distance between each fin being at least 4:1.

5. A method as claimed in claim 4, in which the distance between each fin in the range of from 1.5 to 2.5 microns and the length of the edge of each fin parallel to the longitudinal axis of the sensor in the range of from 20 to 30, microns, the ratio of said length of the edge of each fin to the distance between each fin being at least 8:1.

6. A method as claimed in claim 4, in which the transverse width of the sensor excluding the fins is in the range of from 15 to 55 and the transverse width of each fin is in the range of from 15 to 55 microns.

7. A method as claimed in claim 1, in which the sensor comprises a thin film on a substrate, and the main stripe of said film is spaced away from the surface of the magnetic sheet.

8. A method as claimed in claim 1, in which each outer sheet of the sheet product is made of paper.

9. A method as claimed in claim 1, in which each outer sheet of the sheet product is sufficiently opaque such that, in the finished product, the appearance of the magnetic layer is masked.

10. A method as claimed in claim 1, in which the magnetic layer of the sheet product comprises chromium dioxide, iron oxide, a polycrystalline nickel-cobalt alloy, a cobalt-chromium or cobalt-samarium alloy, and/or barium-ferrite.

11. A method as claimed in claim 1, in which the magnetic layer of the sheet product comprises a binder selected from a polyvinyl alcohol, a latex, a starch, and/or a proteinaceous binder.

12. A method as claimed in claim 1, in which one or both of the outer sheets of the sheet product carries a pigment/binder coat on its inward facing surface.

13. A method as claimed in claim 1, in which one or both of the outer sheets of the sheet product carries at least one additional layer on its outward facing surface, said layer being selected from microcapsules containing a solution of at least one chromogenic material; dispersed droplets containing at least one chromogenic material in a pressure-rupturable matrix; a colour developer composition; both microcapsules containing at least one chromogenic material and also a colour developer; and a thermal coating or a layer of thermal ink.

14. A method as claimed in claim 1, in which the magnetic layer of the sheet product contains from 1 to 7 gm⁻² of magnetic pigment.

15. A method as claimed in claim 14, in which the magnetic layer contains from 1 to 4.5 gm⁻² of magnetic pigment.

16. A method of reading magnetic data from a magnetically-activatable sheet product carrying magnetic data, said product comprising a pair of laminated outer sheets between which is a magnetic layer comprising magnetically-activatable particles in a binder matrix, the method comprising the steps of:
using a thin-film magnetoresistive sensor, in which the shape anisotropy of the sensor is enhanced in a direction transversely to the longitudinal axis of the sensor, to obtain an electrical signal from the magnetic data on the sheet product,
detecting the peaks in the electrical signal obtained from the magnetic data on the sheet product,
identifying the peaks in the electrical signal obtained from the magnetic data on the sheet product as true peaks or false peaks, and
using the peaks identified as true peaks in the electrical signal obtained from the magnetic data on the sheet product to provide an output representing the magnetic data on the sheet product.

17. A method as claimed in claim 16, further including the steps of:
defining windows within which peaks cannot lie if they are valid representations of the magnetic data stored on the sheet product, and
identifying true peaks and false peaks according to where the peaks occur in relation to the windows.

18. A method as claimed in claim 17, wherein peaks are detected in the electrical signal obtained from the magnetic data on the sheet product by determining the slope of the electrical signal at a multiplicity of points.

19. A method as claimed in claim 18, wherein the slope of the electrical signal obtained from the magnetic data on the sheet product is determined by repeatedly sampling the electrical signal and subtracting the value of a current sample from the value of the preceding sample.

20. A method as claimed in claim 19, wherein a change in the sign of the result of subtracting the value of a current sample from the value of the preceding sample is used to indicate the presence of a peak.

21. A method as claimed in claim 19, wherein each window corresponds to a predetermined number of sampling periods.

22. A method as claimed in claim 17, further including the step of commencing a new window on the detection of each true peak.

23. A method as claimed in claim 17, wherein the electrical signal obtained from the magnetic data on the sheet product is processed digitally.

24. A method as claimed in claim 17, wherein the step of using a thin-film magnetoresistive sensor, in which the shape anisotropy of the sensor is enhanced in a direction transversely to the longitudinal axis of the sensor, to obtain an electrical signal from the magnetic data on the sheet product comprises using the sensor to read data recorded using a self-clocking digital code on the sheet product.

25. A method as claimed in claim 16, comprising the step of using the sensor to read data recorded using Manchester code.

26. A method as claimed in claim 24, wherein each window is smaller than the minimum spacing between true peaks expected from the coding format of the magnetic data but larger than the spacing between a true peak and a false peak.

27. A method as claimed in claim 16, further including the step of amplifying the electrical signal obtained from the magnetic data on the sheet product using amplifying means and adjusting the gain of the amplifying means to increase the gain if the electrical signal obtained from the magnetic data on the sheet product is too small and to decrease the gain if the electrical signal obtained from the magnetic data on the sheet product is too large for the amplifying means.

28. A method as claimed in claim 16, wherein the method includes a method of reading magnetic data from a magnetically-activatable sheet product carrying magnetic data, said product comprising a pair of laminated outer sheets between which is a magnetic layer comprising magnetically-activatable particles in a binder matrix, wherein there is used a thin-film magnetoresistive sensor, in which the shape anisotropy of the sensor is enhanced in a direction transversely to the longitudinal axis of the sensor and in which the sensor comprises a thin film on a substrate, and said film is provided with transverse fins.

29. A method of reading magnetic data from a magnetically-activatable sheet product carrying magnetic data, said product comprising a pair of laminated outer sheets between which is a magnetic layer comprising magnetically-activatable particles in a binder matrix, the method being substantially as herein described with reference to, and as illustrated by, the accompanying drawings.

30. A thin-film magnetoresistive sensor, which comprises a thin film on a substrate, said film being provided with a plurality of transverse fins of rectangular shape; characterised in that the distance between each fin is in the range of from 1 to 12 microns, and the length of the edge of each fin parallel to the longitudinal axis of the sensor is in the range of from 15 to 55 microns; the ratio of said length of the edge of each fin to the distance between each fin being at least 4:1.

31. A sensor as claimed in claim 30, in which the distance between each fin in the range of from 1.5 to 2.5 microns and the length of the edge of each fin parallel to the longitudinal axis of the sensor in the range of from 20 to 30, microns, the ratio of said length of the edge of each fin to the distance between each fin being at least 8:1.

32. A sensor as claimed in claim 30, in which the transverse width of the sensor excluding the fins is in the range of from 15 to 55 and the transverse width of each fin is in the range of from 15 to 55 microns.
